(19) United States
(12) Patent Application Publication
(10) Pub. No.: US 2008/0092694 A1
(43) Pub. Date: Apr. 24, 2008

(54) Knife Comprising an Upset Forged Bolster

(75) Inventor: Foachim Droese, Langenfeld (DE)

Correspondence Address: HARNESS, DICKEY & PIERCE, P.L.C., P.O. BOX 828, BLOOMFIELD HILLS, MI, 48303, US

(73) Assignee: Zwilling J.A. Henckel AG, Solingen (DE)

(21) Appl. No.: 11/661,573

(22) PCT Filed: Jan. 28, 2006
(86) PCT No.: PCT/EP06/00743

§ 371 Date: Feb. 28, 2007

(30) Foreign Application Priority Data
Feb. 5, 2005 (DE) 102005005640.7

(51) Int. Cl. B26B 3/00; B21J 5/08; B21K 11/02

(52) U.S. Cl. 76/104.1; 219/152; 219/162; 30/350

(57) ABSTRACT

The invention relates to a knife comprising an upset forged bolster (18) as well as a method for producing such a knife.

The present invention relates to a knife with a bolster and a procedure for manufacturing such a knife.

Knives of the aforementioned kind and corresponding manufacturing procedures are already known. In the classical manufacturing method, the knife, consisting of the blade, the bolster and the knife tang, is forged in one piece. Since the cross-sectional area of the blade, of the bolster, and of the tang differ significantly from each other, the largest cross-sectional area, namely that of the bolster, is consequently usually decisive for the selection of the cross-sectional area of the blank with the classical manufacturing method. This cross-sectional area of the blank must then be reduced by forging (drop-forging) in order to produce the blade and the tang, which has proved to be very complex, since for instance the cross-sectional areas of the bolster and of the blade are very different.

U.S. Pat. No. 689,046 and FR-PS 694 520 describe a knife and its production, whereby the blade, the bolster and the tang are forged separately from each other, possibly from different materials, and subsequently welded together. In comparison with the classical manufacturing method described before, the manufacturing costs are reduced. However, due to process-induced imprecise manufacture of individual components, significant finishing work is required here as well, in particular at the joint surfaces for the welding process.

EP-A-0429035 describes a knife and its manufacture, where the blade, the bolster and the tang are also manufactured separately and are subsequently welded together. Here, however, the bolster is not forged, but sintered, thereby enabling a more precise manufacture of the bolster, and consequently an improvement of the surface quality of the joint surfaces for the subsequent welding process. Finishing is normally not required in this case. However, since the individual components must be welded together subsequent to their manufacture, the number of process steps is very large. Moreover, sintering the bolster is relatively expensive and takes a comparatively long time.

It is one of the main objects of the present invention to create a knife with a bolster which can be manufactured in a simple manner, with as few process steps as possible, and inexpensively.

In accordance with the present invention, this object is solved by a knife in accordance with claim 1 and by a procedure in accordance with claim 14:

According to the invention, the knife comprises an upset-forged bolster. During upset-forging, the cross-section of the blank is not reduced, but rather increased in the area worked on, so that not the largest cross-sectional area, i.e. the cross-sectional area of the bolster, is decisive for the selection of the blank, any more. In accordance with the invention, an essentially flat blank may be used the cross-sectional area of which corresponds to that of the blade and/or of the tang. This blank is then upset in the area of the bolster to be produced, such that the blank folds in this area until the desired larger cross-sectional area for the bolster has been produced. An essential advantage is that when forging the blank, only the bolster needs to be worked on, but not the blade and the tang. The advantage of this method is that the material thickness of tang and blade, and therefore the original steel quality, remains the same. Also the central axis of the blank and its initial thickness are influenced only very little by the forging process, so that the result of the working process is considerably more precise. The dimensional variations of a lot and the component tolerances are clearly less in comparison with conventional forging. The precisely manufactured forging blank also has a positive influence on the precision and the quality of all subsequent process steps. Subsequent to the forging process, the shape of the blade and of the tang may for instance simply be punched out, since the blank used already has the cross-sectional area required for the blade and the tang. Another advantage is that the knife consisting of a blade, a bolster and a tang can be formed from a one-piece blank, while at the same time, the manufacture is more precise and involves less effort in comparison to the classical manufacturing method. In comparison with the manufacture from several blanks, the production from a one-piece blank is advantageous in that it is not necessary to join the blade, the bolster and the tang. Correspondingly, certain process steps and the requirements placed on the joint surfaces required for welding are omitted.

As mentioned before, the blade, the bolster and the tang are preferably formed in one piece for the said reasons.

The blank used preferably comprises several material layers, whereby at least one material layer has a high hardness, preferably between 54 and 70 HRC, better still in the range of 66 HRC. This at least one material layer forms the blade surface of the finished knife. The material used is preferably steel, the carbon content of which determines its hardenability. The carbon content should not fall short of 0.5% by weight on the one hand, and not exceed 2% by weight on the other hand, since otherwise, the steel would be too brittle and therefore fracture-prone. The steel may furthermore comprise other alloying elements, as e.g. manganese, chromium, molybdenum, vanadium, or tungsten. Manganese makes the steel more solid and better forgeable. Chromium also increases the solidity of the steel, makes it more abrasion-resistant due to the formation of chromium carbide, and increases its corrosion resistance. Starting from a chromium content of approx. 12%, steel is considered stainless or rustproof, respectively. Molybdenum enhances the cutting stability and endurance of the steel, in particular in combination with vanadium. Finally, tungsten increases the solidity, and considerably enhances the hardness and edge retention. By the selection of the alloying elements and their contents, particular properties of the steel can be adjusted. However, hardness, edge retention and insusceptibility to breaking are of primary interest here, since this material layer is supposed to form the cutting face.

The at least one material layer with high hardness is preferably arranged in the core area of the blank and therefore of the later produced knife blade, such that the cutting face of the knife to be manufactured is arranged centrally. This hard material layer may also be arranged excentrically, if so desired. The core area preferably comprises at least 50% of the entire blade thickness and of the overall cross-sectional area of the blade, respectively, so that for instance when grinding or regrinding the finished knife, it is indeed the cutting face which is ground. In order to ensure that the core area is arranged as centrally as possible, the number of material layers is preferably odd.

The other material layers preferably enclosing the hard core area preferably have a lower hardness than the core area and are essentially stainless. The advantage of the latter is that the carbon-containing steel of the core area which strongly tends to rust is protected against the atmosphere by these stainless material layers enclosing it.

The visible transitions between the material layers, for instance on the knife back, on the bolster or on the blade, are preferably etched in order to make visible the texture resulting from the multilayeredness. This occurs mainly for the sake of visual effect. Due to the folding of the multilayered blank, in particular the upset-forged bolster has an individual pattern which is reminiscent of Damascus steel.

According to the procedure of the invention, the blade, the bolster and the tang are preferably formed from a one-piece blank. In this manner, any joining operations can be omitted after forging. Due to the fact that the bolster is formed by means of upset-forging, it is ensured also with a one-piece blank that the manufacture is precise and not too complex.

The blank is preferably punched from a multilayered metal sheet, heated by means of resistance heating and upset or folded, respectively, in the area of the bolster to be produced in the upset-forging step.

The upset-forging step or the result of the upset-forging step, respectively, depends essentially from the upsetting course, the upsetting speed and the temperature regulation. The temperature is preferably 1,050° C.; however, the temperature depends on the material.

The upset-forging step is preferably followed by a precision-forging step, in particular in order to work out precisely individual outlines of the bolster. The result of the precision-forging step depends essentially on the traversing rate of the upper die, the pressing force, the travel, the contact making time, and the cooling lubricant used. The precision-forging step of the bolster preferably comprises only one stroke.

Finally, the outline of the knife is preferably trimmed away or punched out, respectively.

The procedure described above enables very precise and inexpensive manufacture, whereby the procedure comprises few process steps and can do without any joining steps. Power consumption, the amount of steel used, surface and noise are considerably reduced.

As described before, the blank used for the procedure described above comprises several layers, preferably with a centrally arranged steel layer with high hardness, which should finally form the cutting face of the knife. When the blank is produced, several layers of sheet metal are cladded and cold-rolled, so that metal sheets are produced from which the blanks can be punched out.

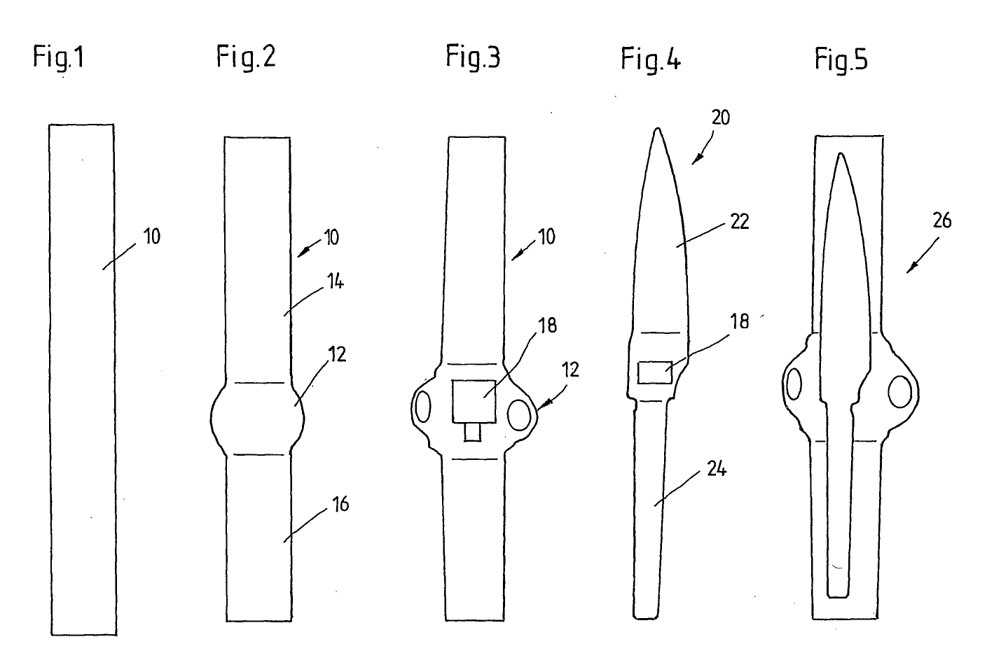

In the following, the present invention is described in more detail with reference to the drawing. In doing so, FIG. 1 to FIG. 5 represent individual results of consecutive process steps in accordance with a preferred embodiment of the procedure according to the invention.

In detail are shown in:

FIG. 1 a plan of a blank used in accordance with a preferred embodiment of the procedure according to the invention;

FIG. 2 a plan of the blank shown in FIG. 1 after the upset-forging step according to the invention has been carried out;

FIG. 3 a plan of the blank shown in FIG. 2 after a precision-forging step has been carried out;

FIG. 4 a plan of the blank shown in FIG. 3 after a trimming step has been carried out;

FIG. 5 a plan of the waste piece created by the trimming step, which is put to recycling as steel scrap, and

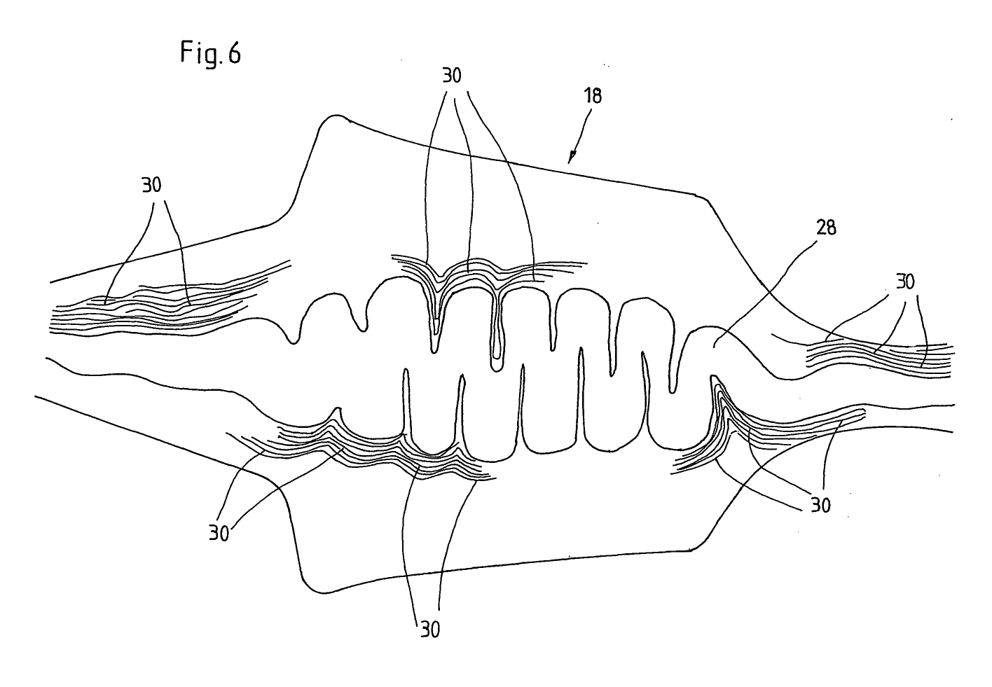

FIG. 6 an enlarged cross-sectional view of the upset, multi-layered bolster.

FIG. 1 shows a blank 10 which is used to realise a preferred embodiment of the procedure according to the invention. The blank 10 is a strip of multilayer steel, for instance 3-layered, up to Damascus-like clad-composites, e.g. 33-layered. In the centre of its cross-sectional area, the blank 10 has a layer of steel with high hardness, in the present case 66 HRC. This material layer takes up approximately 50% of the overall thickness of the blade or of the overall cross-sectional area of the knife, respectively, and forms the cutting face of the knife to be produced.

The blank 10 shown in FIG. 1 was punched out from a large, cold-rolled multilayer steel sheet which has the desired cross-sectional area of the blade and the tang. Analogously, the blank 10 also has the corresponding cross-sectional area.

FIG. 2 shows blank 10 from FIG. 1 after the upset-forging step according to the invention has been carried out. As can be seen, the material in area 12, where the bolster to be produced is to be formed, is folded in such a way that the cross-sectional area in area 12 has been enlarged in accordance with the desired cross-sectional area of the bolster. The areas 14 and 16, from which the blade and the tang will be formed later on, have not been changed essentially by the upset-forging step. Upsetting is effected by resistance heating. At this point, it should be clear that the heating can also be effected by a different method.

FIG. 3 shows the blank 10 from FIG. 2, now after a precision-forging step has been carried out, by which the shape of the bolster 18 was formed in area 12. Precision-forging consists of carrying out one single stroke. Furthermore, more than one stroke may be carried out in the precision-forging step, whereas it is of course preferred that the shape of the bolster can be produced with sufficient precision by one single stroke. As can be seen in FIG. 3, the areas 14 and 16, from which the blade and the tang are produced, remain essentially unchanged, also when the precision-forging step is carried out.

FIG. 4 shows the finished part 20, which is produced when the blank 10 shown in FIG. 3 undergoes a trimming step. During this trimming step, the respective outlines of the blade 22, of the bolster 18 and of the tang 24 are punched out.

FIG. 5 shows the trimmed-away part 26 generated by the trimming step. As can be seen, only a small amount of waste is produced in the procedure according to the invention.

FIG. 6 finally shows an enlarged cross-sectional view of the upset, multilayered bolster 18. The material layer 28 with high hardness which is essentially arranged centrally, i.e. in the core area, extends through the bolster 18 in a meander-like folded manner. It takes up approx. 50% of the cross-sectional area and is enclosed by other, significantly thinner and also folded material layers 30, which, however, are only partly adumbrated in FIG. 6. It should be clear that the material layers 30 extend through the entire bolster 18 above and below material layer 28, and run parallel to the forming of bolster 18. These material layers 30 are softer than material layer 28 and are corrosion-resistant in order to protect material layer 28 against negative atmospheric influences. It can be seen from FIG. 6 that by appropriate grinding and etching of the ground surface, the individual pattern can be brought to light, which may be particularly desirable for visual effects.

It should be clear that the embodiment of the procedure according to the invention described above and the knife with a bolster according to the invention which is presented in an exemplary fashion are not restrictive with regard to the scope of protection defined by the enclosed claims. On the contrary, modifications and changes are possible without leaving the latter.

### LIST OF REFERENCE NUMERALS

10 Blank
12 Area
14 Area
16 Area
18 Bolster
20 Finished part
22 Blade
24 Tang
26 Trimmed-away part
28 Central material layer
30 Other material layer

1. A knife with upset-forged bolster.

2. A knife according to claim 1, wherein the blade, the bolster, and the tang are formed in one piece.

3. A knife in accordance with claim 1, wherein the knife has several material layers.

4. A knife in accordance with claim 3, wherein the several material layers are a multilayer steel.

5. A knife in accordance with claim 3, wherein at least one material layer has a high hardness.

6. A knife in accordance with claim 5, wherein the hardness of this at least one material layer is 54 to 70 HRC and is preferably in a range of 66 HRC.

7. A knife in accordance with claim 5, wherein the material layer with high hardness is a hardened steel with a carbon content between 0.5% and 2%.

8. A knife in accordance with claim 5, wherein the at least one material layer with high hardness is essentially centrally arranged in a core area.

9. A knife in accordance with claim 8, wherein the thickness of the core area takes up at least 50% of the overall thickness of the blade.

10. A knife in accordance with claim 3, wherein the number of material layers is odd.

11. A knife in accordance with claim 5, wherein the other material layers have a lower hardness than the material layer with high hardness.

12. A knife in accordance with claim 5, wherein the other material layers are essentially stainless.

13. A knife in accordance with claim 3, wherein visible transitions between material layers are at least partly etched.

14. A procedure for the manufacture of a knife with a bolster, wherein an upset-forging step is provided to form the bolster.

15. A procedure in accordance with claim 14, wherein the blank used for the upset-forging step is preheated.

16. A procedure in accordance with claim 15, wherein the blank is heated by resistance heating.

17. A procedure in accordance with claim 14, wherein the blank used for the upset-forging step has several material layers.

18. A procedure in accordance with claim 14, wherein the blank used for the upset-forging step is cold-rolled.

19. A procedure in accordance with claim 14, wherein the blank used for the upset-forging step comprises at least one material layer with high hardness.

20. A procedure in accordance with claim 19, wherein this at least one material layer has a hardness of 54 to 70 HRC, or better still a hardness in the range of 66 HRC.

21. A procedure in accordance with claim 19, wherein this at least one material layer is hardened steel with a carbon content between 0.5% and 2%.

22. A procedure in accordance with claim 19, wherein this at least one material layer is provided essentially centrally in the core area of the blank.

23. A procedure in accordance with claim 19, wherein the other material layers have a lower hardness than the material layer with high hardness.

24. A procedure in accordance with claim 19, wherein the other material layers are essentially stainless.

25. A procedure in accordance with claim 14, wherein the blank used for the upset-forging step is punched out.

26. A procedure in accordance with claim 14, wherein the blade, the bolster, and the tang are formed from a one-piece blank.

27. A procedure in accordance with claim 14, wherein the upset-forging step is followed by a precision-forging step for further formation of the bolster.

28. A procedure in accordance with claim 27, wherein the precision forging step comprises exactly one stroke.

29. A procedure in accordance with claim 14, wherein the outline of the knife with the bolster is trimmed away.

30. A procedure in accordance with claim 17, wherein visible transitions between material layers are at least partly etched.
